(19) United States
(12) Patent Application Publication
(10) Pub. No.: US 2006/0226295 A1
(43) Pub. Date: Oct. 12, 2006

(54) Lifting body tuned for passive re-entry

(76) Inventors: Douglas S. Gulick, Littleton, CO (US); Joseph V. Bomba, Highlands Ranch, CO (US)

Correspondence Address: MARSH, FISCHMANN & BREYFOGLE LLP, 3151 SOUTH VAUGHN WAY, SUITE 411, AURORA, CO, 80014, US

(21) Appl. No.: 11/090,928

(22) Filed: Mar. 25, 2005

(51) Int. Cl. B64G 1/00

(52) U.S. Cl. 244/158.9

(57) ABSTRACT

A high performance (high L/D ratio) launch vehicle is tuned for passive or limited control re-entry. In one embodiment, the re-entry vehicle (100) includes a fuselage portion (102) and wing portions (104 and 106) extending from opposite sides thereof. Various vehicle configuration parameters are tuned to allow for passive or limited control re-entry. In particular, the swept wings have a dihedral configuration and the nose of the vehicle (100) is widened. In operation, the vehicle (100) penetrates the outer atmosphere at a high angle of attack and transitions to an aerodynamic angle of attack for substantial cross range and down range control within the lower atmosphere. The vehicle (100) thereby provides for enhanced re-entry safety while reducing propellant requirements, reducing loads and meeting human rating requirements.

### FIELD OF THE INVENTION

The present invention relates generally to re-entry vehicles and, in particular, to a vehicle adapted for passive re-entry, like a capsule, and aerodynamically controlled gliding or powered flight, like an aerospace plane.

### BACKGROUND OF THE INVENTION

One of the most challenging aspects of space flight is atmospheric re-entry, i.e., penetration of the Earth's outer atmosphere and descent to the Earth's surface. Upon re-entry, the re-entry vehicle, generally moving at a near-orbital velocity, meets the outer atmosphere resulting in substantial friction, drag and other aerodynamic forces. These forces generate tremendous heat and entail significant control issues. Failure to protect against the heat of re-entry or to adequately address control issues can result in catastrophic failure. The loss of the U.S. Space Shuttle Columbia provides a grim illustration of the potential consequences in this regard.

Protection against the heat of re-entry is generally provided by heat tiles or similar materials. These are carefully designed and placed to protect crew and equipment against dangerous heating. Vehicle control during re-entry is important in a number of respects. First, the spacecraft attitude must generally be controlled so that the heat tile protected surfaces are properly oriented relative to the wind vector so as to provide the desired protection. Additionally, a particular attitude is generally required to achieve the desired level of drag and deceleration. Moreover, particularly in the case of manned flight, angular motion must generally be carefully controlled with respect to the roll, pitch and yaw axes. In particular, the acceleration that can be tolerated by crew members is limited. NASA has defined human rating requirements, including human safety standards for manned space flight. See Human-Rating Requirements and Guidelines for Space Flight Systems w/Change 2 (Jun. 25, 2004) (NPR8705.2), which is incorporated herein by reference. These requirements, together with certain parameters relating to crew seating configurations, define maximum acceptable angular velocities with respect to the roll, pitch and yaw axes

Accordingly, attitude control upon re-entry is an important design consideration. Generally, re-entry may be classified as passive or active in this regard. Active re-entry involves the use of sensor feedback and thrusters to maintain vehicle attitude and rotation within applicable requirements. Typically, sensors monitor angular position or derivatives thereof with respect to pitch, roll and yaw axes and thrusters such as impulse engines make appropriate corrections. Passive or ballistic re-entry generally indicates that vehicle attitude and rotation is maintained within applicable requirements without such active correction. In some cases, active control may be utilized with respect to less than all-three axes, e.g., single-axis roll control. Moreover, vehicles that are capable of passive re-entry may use thrusters for fine tuning attitude or to change attitude at different phases of re-entry and descent as may be desired.

Generally, passive re-entry has been limited to capsules. Capsules are characterized by a generally symmetrical configuration relative to a central axis which maintains a defined orientation relative to the wind vector during re-entry. Due to this configuration, capsules experience little or no moment relative to the three axes of rotation due to aerodynamic forces and generally remain stable.

However, it is sometimes desired to utilize a lifting body for re-entry. Lifting bodies are characterized by lift-to-drag (L/D) ratios exceeding that of capsules and generally have an L/D greater than 0.3. Lifting body re-entry vehicles include the U.S. Space Shuttle and the proposed Orbital Space Plane (OSP). These lifting body re-entry vehicles are useful because they allow for some degree of aerodynamic control of the cross-range and/or down-range descent path, for example, to enable targeted parachute or runway landings. In addition, lifting body re-entry vehicles allow for reduced acceleration (g-load) landings. It is generally desirable to provide a high L/D in this regard, e.g., greater than 0.6.

Today, the shuttle fleet remains grounded in the aftermath of the Columbia disaster. That disaster looms large in the planning for future space flight, especially manned space flight. Many in the aerospace community are assuming that practical or regulatory requirements will compel designers to provide either passive control capability or escape pod functionality for all stages of re-entry. Given that escape pod functionality imposes significant constraints on vehicle design and payload, some believe that a return to capsule-only re-entry for manned space flight is inevitable; that is, that capsule only re-entry is being practically if not explicitly required.

### SUMMARY OF THE INVENTION

The present invention is directed to a re-entry vehicle and associated methodology that satisfies practical constraints relating to re-entry safety while allowing for lifting body functionality and associated advantages relating to descent path control and load reduction. The re-entry vehicle of the present invention has a configuration that allows for passive re-entry such that, in the case of manned flight, applicable safety standards can be satisfied without compromises to accommodate an escape pod. Even in the case of unmanned flight, propellant requirements and risks to equipment and missions can be significantly reduced in relation to controlled re-entry. Moreover, the invention allows for lifting body performance, for example, in the lower atmosphere, so as to enable substantial cross-range and/or down-range descent path control and reduced accelerations. High L/D ratios and active aerodynamic control can be accommodated so as to enable runway landings.

The present inventors have recognized that passive re-entry is not limited to vehicle configurations having capsule-like symmetry. Rather, higher performance vehicles (higher L/D configurations) can achieve passive re-entry capability through aerodynamic tuning. This can be accomplished by balancing the yaw moment over the roll moment to the negative of the axial force coefficient over the normal force coefficient for hypersonic flight as reflected in the following formula:
c_{nβ}/c_{1β}=−C_{A}/C_{N} (1)

where:

c_{nβ}=yaw moment;

c_{1β}=roll moment;

C_{A}=axial force coefficient; and

C_{N}=normal force coefficient.

The present invention thus relates to turning a baseline design for a lifting body re-entry vehicle, or establishing an initial design, to more closely satisfy this equation, thereby reducing or substantially eliminating the need for active re-entry stability control. This equation, surprisingly, can be balanced for high performance vehicle configurations by careful aerodynamic tuning. Similarly, such tuning to more nearly satisfy this equation can reduce attitude control and propellant required during re-entry.

In accordance with one aspect of the present invention, a lifting body re-entry vehicle is provided that allows for passive re-entry. The vehicle includes internal structure defining a payload compartment (e.g., for crew and/or equipment) and external structure defining a lifting body wherein, for a given attitude (e.g., angle of attack relative to a wind vector), the external structure provides an L/D ratio greater than about 0.3. Moreover, for specified initial conditions regarding re-entry (e.g., specified orbital velocity, atmospheric incidence angle and attitude), the re-entry vehicle is configured in a manner that enables passive re-entry such that a status of the re-entry vehicle with respect to each of a yaw, a roll and a pitch axis can be maintained within defined limits throughout at least a portion of a descent path extending through an upper area of the Earth's atmosphere substantially free from the use of control thrusters for angular instability control. For example, in the case of manned space flight, the vehicle configuration may allow for passive control so that passenger seating locations maintain acceleration/angular velocities within the above-noted Human Rating Requirements throughout descent across the upper atmosphere. Generally, this will require that rotation relative to all three axes be maintained at low levels, e.g., less than 60 rpm. In one implementation, the vehicle is stable with respect to one or more axes (e.g., pitch and yaw) while rolling, in passive reentry mode, with respect to another axis (e.g., relative to the lift vector) such that lift nulls out over time. Such rolling can be eliminated by using thrusters, but passive reentry can be accomplished in case of active control failure. It will be appreciated that active components, though generally not required for angular stability control, may be provided for attitude control as may be desired.

According to another aspect of the present invention a re-entry vehicle is provided that includes a lifting surface and allows for passive re-entry. The vehicle includes a central body portion and at least one lifting surface extending from the body and configured so as to provide aerodynamic lift during at least a portion of a descent path extending through a lower area of the Earth's atmosphere. For example, the lifting surface may be configured to provide a lower air pressure and cumulative pressure load on an upper surface than on a lower surface thereof for a given angle of attack. In one embodiment, the vehicle includes first and second wing portions extending from opposite sides of the central body portion. These wing portions may define a continuous bi-convex surface that generally faces the wind vector during re-entry.

According to a still further aspect of the present invention, a passive re-entry vehicle is provided that is capable of active aerodynamic control. The vehicle includes a body and at least one aerodynamic control surface for aerodynamically controlling an attitude of the vehicle during at least a portion of a descent path, e.g., within the lower atmosphere. For example, the vehicle may include flaps or the like for pitch/roll control as well as lift control and/or rudders or the like for yaw control. In this manner, significant guidance can be provided with respect to the descent path.

According to a still further aspect of the present invention, a high lift vehicle is provided that is capable of at least one degree of passive re-entry control. The vehicle includes internal structure defining a payload compartment and exterior structure defining a lifting body wherein, for a given angle of attack relative to a wind vector, the external structure provide an L/D ratio of at least about 0.6. In addition, for specified initial conditions regarding re-entry, the vehicle is configured in a manner that enables passive control with respect to at least one of a pitch, a roll and a yaw axis such that a status with respect to that axis is maintained within defined limits throughout a portion of a descent path substantially free from use of thrusters for angular stability control with respect to that axis. For example, the vehicle may allow for fully passive re-entry or for single axis active control, e.g., active roll control only. The high lift configuration allows for substantial descent path control and possible controlled, runway landings.

According to another aspect of the present invention, a novel method is provided for use in re-entry. The method includes the steps of: controlling a re-entry vehicle so as to provide desired conditions for penetrating an outer extent of the Earth's atmosphere; passively re-entering the Earth's atmosphere such that any angular motion of the re-entry vehicle with respect to each of a pitch, a roll and a yaw axis remains within defined limits throughout a first portion of a descent path substantially free from use of thrusters for angular stability control; and using aerodynamic surfaces of the re-entry vehicle to control a second portion of the descent path. For example, passive re-entry may be supported throughout the descent path or at least within the upper atmosphere and the aerodynamic surfaces may be employed to control the descent path of at least within the lower atmosphere. Accordingly, the first and second portions of the descent path may at least partially overlap. The aerodynamic surfaces may be passive and/or active. In this regard, fixed wing surfaces may be used, for example, with appropriate mechanisms for controlling an attitude including an angle of attack, to allow for at least substantial down-range glide path control. Additionally or alternatively, deployable aerodynamic control surfaces may be used for pitch, roll or yaw control, as well as for cross-range and/or down-range glide path control.

In one embodiment, a lifting body re-entry vehicle is tuned for passive re-entry. The vehicle generally has an aerospace plane configuration with a fuselage body, including a crew or equipment compartment, and wings extending from opposite sides thereof and defining a continuous bottom vehicle surface. The configuration may alternatively be characterized as a flying wing. This basic configuration may be tuned in a number of ways to achieve the desired passive re-entry capability. First, the noted lower surface of the vehicle, which is adapted for generally facing the wind vector upon re-entry, preferably has a bi-convex configuration. That is, the lower surface is preferably downwardly convex (convex as viewed from below) with respect to both a longitudinal (nose-to-tail) axis and a transverse (wingtip-to-wingtip) axis. In this regard, the wings may have a dihedral configuration. Moreover, the wings are preferably rearwardly swept and the trailing edge of the wings preferably has a rearwardly convex shape.

In addition, the nose may be broadened to facilitate passive re-entry. For example, the nose—which may be measured from a location of minimum radius of curvature where a forward surface of the vehicle meets a side, bottom or upper surface thereof—may have a transverse dimension that exceeds its vertical dimension. Preferably, the transverse dimension is at least twice the vertical dimension. For example, the nose may have a generally ellipsoid configuration with its major axis substantially aligned with the transverse axis of the vehicle. It will be appreciated that a variety of vehicle configurations and tuning adjustments are possible to achieve the relationship described above relating to passive re-entry.

### BRIEF DESCRIPTION OF THE DRAWINGS

For a more complete understanding of the present invention and further advantages thereof, reference is now made to the following detailed description taken in conjunction with the drawings in which:

FIGS. 1 and 2 are perspective views of a lifting body re-entry vehicle constructed in accordance with the present invention;

FIG. 3 is a side view illustrating an angle of attack of the re-entry vehicle of FIGS. 1 and 2 in comparison to certain conventional and proposed re-entry vehicles;

FIG. 4 is a front view illustrating a front geometry of the re-entry vehicle of FIGS. 1 and 2 in relation to a conventional capsule;

FIG. 5 illustrates descent paths for the re-entry vehicle in accordance with the present invention in relation to the descent path of a conventional capsule;

FIG. 6 illustrates a simulated surface flow diagram for a lifting body re-entry vehicle constructed in accordance with the present invention;

FIG. 7 illustrates a simulated flow field for the re-entry vehicle of FIG. 6; and

FIGS. 8a-14d show results of analyses of certain re-entry vehicle designs in accordance with the present invention.

### DETAILED DESCRIPTION

In the following description, the invention is set forth with respect to specific re-entry vehicle configurations that provide for passive re-entry control for a lifting body re-entry vehicle. It will be appreciated that these particular configurations were achieved by taking a proposed vehicle design, developed based on a variety of mission considerations, and tuning the design, in accordance with certain principles described below, to achieve the desired level of passive re-entry control. Accordingly, it will be appreciated that other designs may be developed in accordance with the present invention. The following description, therefore, should be understood as exemplifying the invention and not by way of limitation.

The following description begins by setting forth the principles which have been found, surprisingly, to allow for passive re-entry control by a high performance re-entry vehicle. Thereafter, the description includes a generalized discussion of a re-entry vehicle and operational variations in accordance with the present invention. Finally, test results are provided for two specific configurations demonstrating achievement of passive re-entry control for high performance re-entry vehicles.

The specific configurations described in detail below were developed by tuning preliminary designs of the proposed Orbital Space Plane (OSP). Earlier designs of the OSP entry configurations were very sensitive to yaw center of pressure or Y cg offsets and required large amounts of RCS propellant if an aerodynamic trim tab was not available. With the new requirements for a backup ballistic entry, loss of control was experienced with RCS only control for small Y cg offsets. An uncontrolled ballistic entry makes the problem worse.

The Y cg problem arises because of the requirement to simultaneously trim both the roll and yaw moment equations shown below.
M_{X}=C₁_{_{β}}βqS_{ref}b_{ref}+C_{N}ΔYqS_{ref}+M_{X}_{_{RCS}}=0 (2)
M_{Z}=Cₙ_{_{β}}βqS_{ref}b−C_{A}ΔYqS_{ref}+M_{Z}_{_{RCS}}=0 (3)
Normally, for a Y cg offset, the moment from the RCS will combine with the sideslip angle, beta, for trim. Depending on the values of the aerodynamic coefficients, the RCS moments can be quite large as was the case for the earlier OSP configurations. Without the RCS there is one independent variable, beta, to satisfy the two moment equations and a general solution for beta is not possible. However, a combination of the aerodynamic coefficients can be found that will satisfy both equations without RCS. The required relation is:

$$\frac{{C}_{{n}_{β}}}{{C}_{{1}_{β}}} = - \frac{{C}_{A}}{{C}_{N}} \qquad ( 4 )$$

The corresponding sideslip angle for trim is given by:

$$β = - \frac{{C}_{N}}{{C}_{{1}_{β}}} \frac{Δ Y}{b} = - \frac{{C}_{A}}{{C}_{{n}_{β}}} \frac{Δ Y}{b} \qquad ( 5 )$$

It has been found that the requirement above can be met at least to a chute deploy condition of Mach 2. Two different design approaches were developed, as described below, that resulted in configurations that closely meet the trim design criteria.

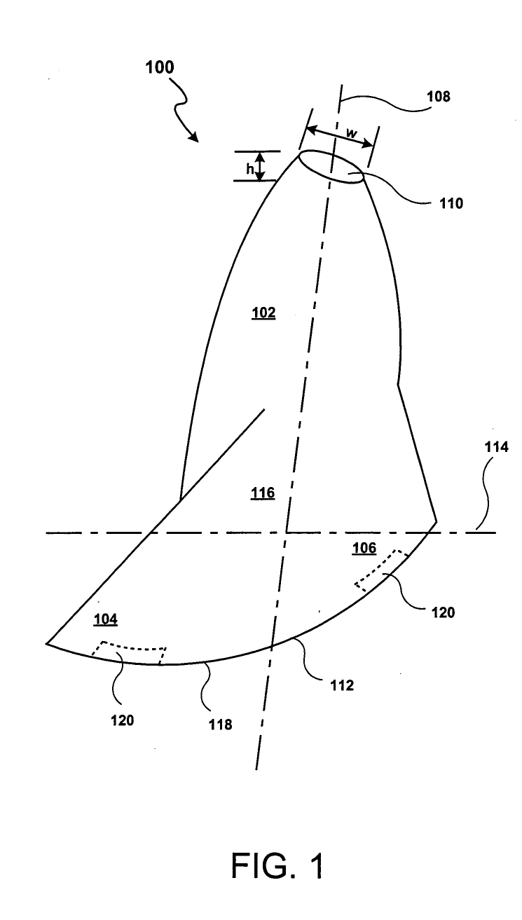

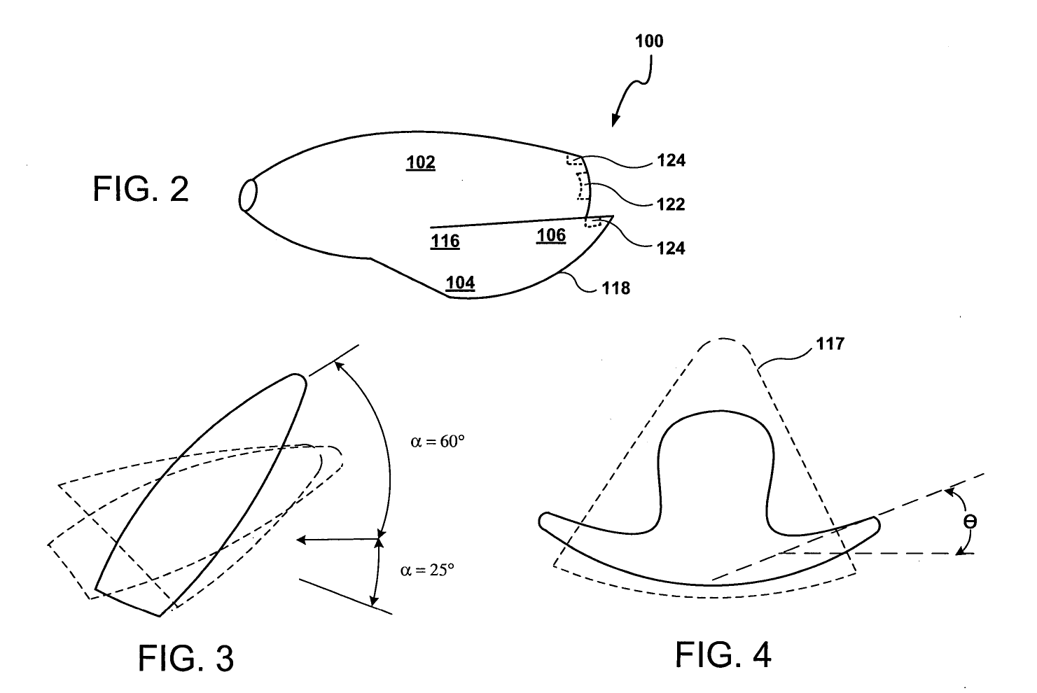

However, prior to presenting those results, some general tuning considerations will be described in relation to FIGS. 1-5. FIGS. 1-2 show bottom and side perspective views, respectively, of a lifting body re-entry vehicle 100 in accordance with the present invention. The vehicle is generally in the form of an aerospace plane, with certain tuning modifications as will be described below. More specifically, the vehicle 100 generally includes a central body or fuselage portion 102 that includes an internal compartment for passengers and/or equipment and wing portions 104 and 106 extending from opposite sides of the fuselage portion 102. Also shown in FIG. 1 are a reference longitudinal axis 108, extending from a nose 110 to a tail end 112 thereof, and a reference transverse axis 114 extending from wingtip to wingtip.

Various modifications may be made to a baseline aerospace plane design to more closely satisfy equation 4 so as to reduce propellant requirements for stability control or to allow for full or partial passive re-entry control. A number of such modifications are reflected in the illustrated vehicle 100. First, a dihedral, swept wing configuration is employed so as to define a vehicle bottom surface 116 that is somewhat closer (relative to a conventional aerospace plane configuration) to that of a conventional capsule 117 (see FIG. 4). That is, the wing portions 104 and 106 are inclined from base to wingtip at an angle θ of preferably between about 20° and 40° and, more preferably, between about 25° and 33°. In the illustrated embodiment, θ is between about 26° and 30°.

The bottom surface 116 of the illustrated vehicle 100 also has a bi-convex configuration. That is, the bottom surface 116 is downwardly convex with respect to each of the longitudinal 108 and transverse 114 axes. In this regard, surface 116 may be thought of as approximating a partial spheroid or ellipsoid surface. The surface 116 is also, preferably, substantially free of edges or other singularities other than at the perimeter thereof. In addition, the wing portions 104 and 106 preferably define a common trailing edge 118 that is rearwardly convex, e.g., partially circular or elliptical.

The illustrated vehicle 100 further includes a broadened nose 110. Preferably, the nose 110 has a width, w, that exceeds its height, h. More preferably, the width is at least twice the height of the nose. The illustrated nose 110 has a generally ellipsoidal configuration with its major axis generally aligned with transverse axis 114.

Referring again to FIGS. 1-2, another parameter that may be adjusted to tune the re-entry vehicle for passive re-entry control is angle of attack. FIG. 3 shows the angle of attack employed during initial re-entry by the lifting body re-entry vehicle 300 of the present invention in relation to that of the baseline OSP design 302 and a conventional capsule 304, in this case, an Apollo capsule. As shown, the conventional capsule employs an angle of attack of −25° whereas the lifting body re-entry vehicle 300 employs angle of attack of 60° which is significantly greater than that of the baseline design 302. In each case, the angle of attack is measured between a longitudinal axis and a wind vector. It will be observed in this regard that while the attitude of vehicle 300 is nearly normal to that of capsule 304, the orientation of the surface facing the wind vector is similar for both vehicles (see also FIG. 4). The vehicle 100 may further include control surfaces and/or impulse motors for active attitude control with respect to the pitch, roll and yaw axes. In this regard, optional wing flaps 120 may be provided to assist in roll and pitch control as well as for reconfiguring the wing portions 104 and 106 for desired lift characteristics and to assist in controlling angle of attack. An optional rudder 122 or rudder-like flaps may be provided to assist in yaw control. Collectively, the control surfaces 120 and 122 together with the wing portions 104 and 106 may provide significant downrange and crossrange control of a descent glide path or powered flight path of vehicle 100. It will be appreciated that the effectiveness of the control surfaces 120 and 122 as well as the wing portions 104 and 106 is highly attitude and angle of attack dependent, and will generally be limited to use within the lower atmosphere, e.g., below about 100,000 feet elevation.

The vehicle 100 may also employ impulse motors or other thrusters for stability control and/or attitude control with respect to one or more of the pitch, roll or yaw axes. Such control may be provided, for example, by dedicated pairs of fixed motors for providing a rotational moment about a given axis, or by gimbaled motors for providing controlled thrust vectoring. In the illustrated embodiment, such thrusters are generally indicated by elements 124 shown at the rear top and wingtip extremities of the vehicle 100. It will be appreciated that the thrusters 124 provide control capabilities throughout the lower and upper atmosphere and beyond. The thrusters may be used for one or more of the following: 1) to provide a desired attitude for penetrating the outer atmosphere, 2) for providing active re-entry stability control with respect to one or more axes, e.g., single-axis roll control, 3) to provide reduced propellant active re-entry stability control with respect to all axes, 4) to provide transitional attitude control to adjust from a desired high atmosphere angle of attack to a low atmosphere, aerodynamic angle of attack, 5) to provide fine tuning of attitude control, 6) to provide active stability control at certain attitude ranges where passive control deteriorates or fails, e.g., below a passive control altitude threshold, etc. Appropriate servo control based on attitude sensors may be employed to control operation of the thrusters.

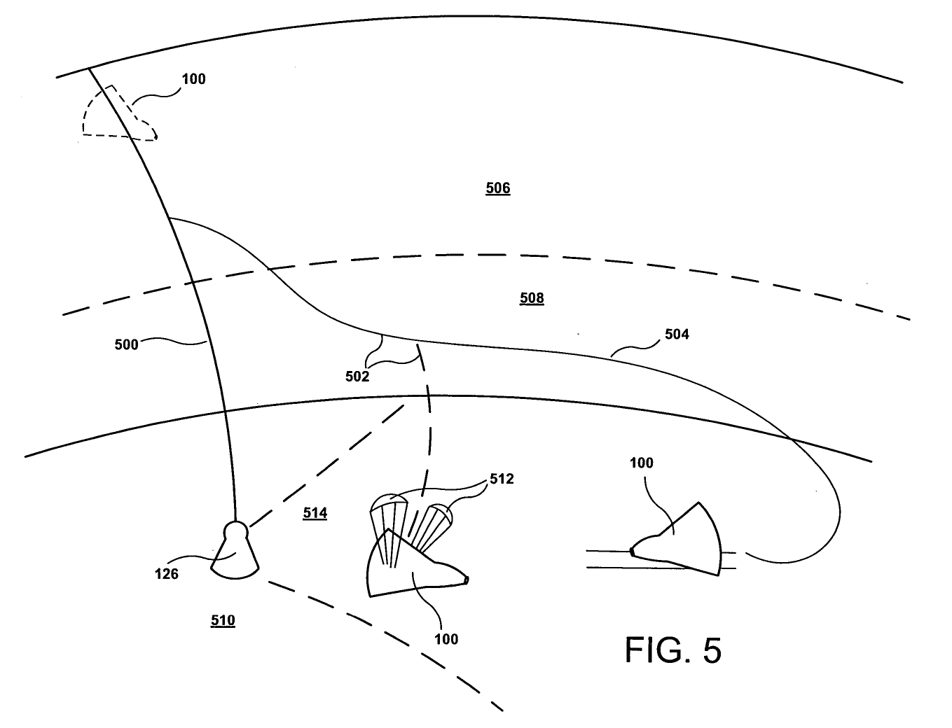

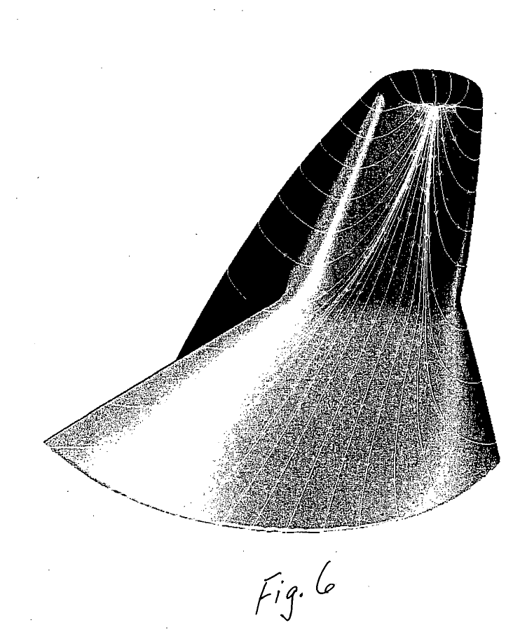

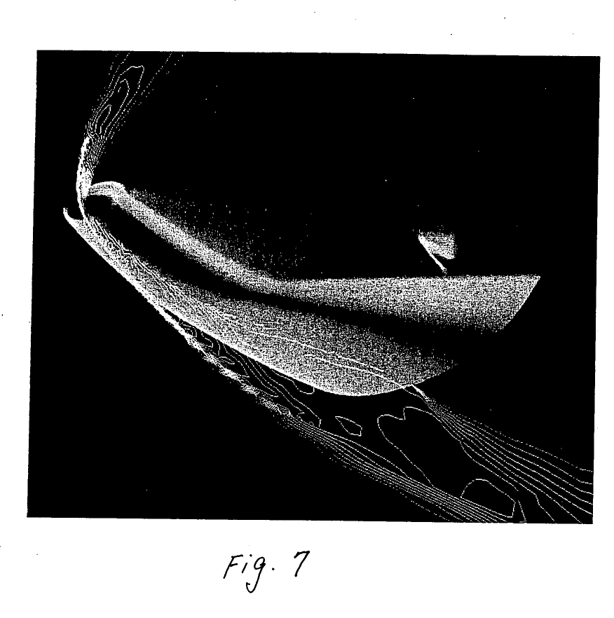

Referring to FIG. 5, certain advantages of the lifting body re-entry vehicle 100 are illustrated in relation to a conventional capsule 126. Three descent paths 500, 502 and 504 are shown. Specifically, path 500 represents a substantially ballistic descent path of a conventional capsule 126 to the Earth's surface 510. Path 502 represents the descent of the lifting body re-entry vehicle of FIG. 1 using parachutes for landing. The path 502 includes a first portion through the upper atmosphere (generally indicated by reference numeral 501) which generally coincides with ballistic path 500, followed by a second portion defining a glide path through the lower atmosphere (generally indicated by reference numeral 508). The glide path is interrupted by deployment of parachutes 512, resulting in the third, drifting portion of descent path 502. For example, the parachutes may be deployed at a vehicle velocity of about Mach 2 or under. Such parachute assisted landing may be employed, for example, in the case of intermediate performance vehicles, e.g., 0.3<L/D<0.6, deemed unsuitable for runway landings or in the case of vehicle configurations having diminished or ineffective passive re-entry stability control below a defined velocity threshold, e.g., Mach 2 or lower.

Path 504 represents a descent path for a runway or other lift assisted (e.g., gliding landing. This path 504 particularly applies to high performance (e.g., L/D>0.6) re-entry vehicle missions. Path 504 includes a first portion through the upper atmosphere 506 that is substantially coincident with the ballistic path 500 and a second portion through the lower atmosphere 508 characterized by aerodynamic gliding or possible powered flight.

With respect to paths 502 and 504, the vehicle 100 penetrates and traverses the upper atmosphere 506 at a high angle of attack. That is, the bottom surface of the vehicle 100 generally faces the wind vector. The bottom surface is thus provided with appropriate heat tiling or other thermal protection to withstand the associated re-entry heat. The associated drag decelerates the vehicle 100 throughout the upper atmosphere 506. As the vehicle 100 reaches the lower atmosphere, gliding mode operation becomes possible due to, among other things, a thicker atmosphere and lower velocities. At this point, the vehicle's attitude is changed from a ballistic angle of attack to an aerodynamic or gliding angle of attack. Additionally, the vehicle's attitude may be controlled to align the vehicle's longitudinal axis with the wind vector. Such attitude control may involve thrusters and/or aerodynamic control surfaces. Such thrusters and control surfaces are further employed in combination with the wing portions of vehicle 100 to enable substantial cross range and downrange control of descent paths 502 and 504 relative to the Earth's surface 510 as generally indicated by surface region 514. It will be appreciated that such control provides significant safety and security advantages. Moreover, the lifting body re-entry vehicle 100 allows for reduced acceleration loads associated with landing.

Two designs tuned in accordance with the present invention have been validated by wind tunnel tests and computer simulations. Specifically, computer simulation was used to shape the high speed (Mach>2) aerodynamic characteristics to satisfy a design criteria resulting in low sensitivity to a Y cg. The resulting configuration has been successfully evaluated in wind tunnel tests with RCS only control down to the chute deploy Mach number of 2 for both a normal entry and an uncontrolled ballistic entry with equivalent combined 3 sigma variations in the Y cg and aerodynamic coefficients. By way of initial summary, for the normal entry with 3 sigma dispersions, computer analysis indicates that less than 200 lbs. of propellant is required. For the uncontrolled ballistic entry, angular rates of approximately 30 rpm result for the 3 sigma dispersions. With nominal aerodynamics, the rates are less than 10 rpm with a Y cg of 0.75 inches. The ballistic entry results in a maximum total load factor of about 8 g's.

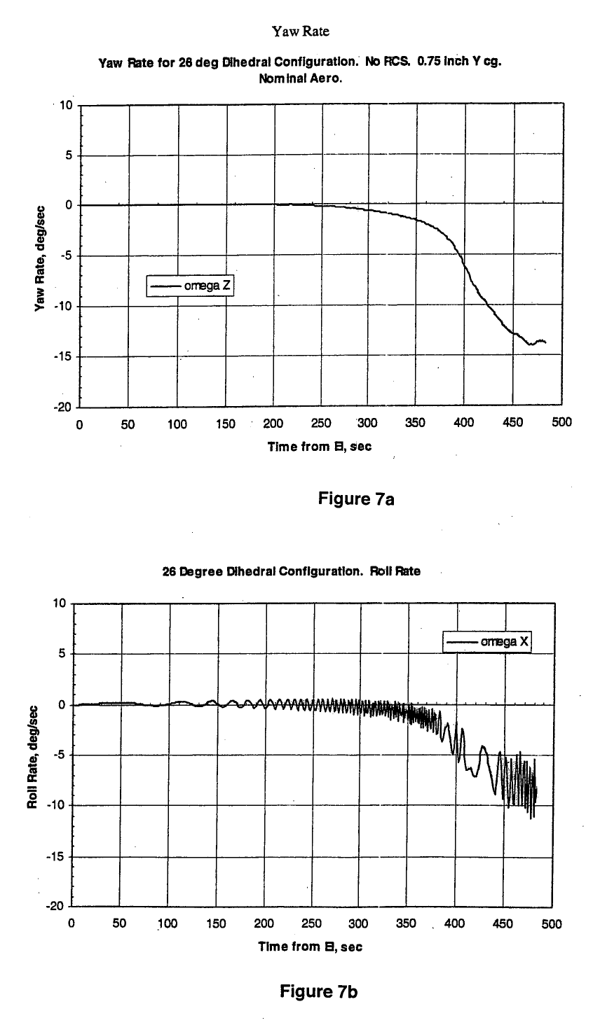

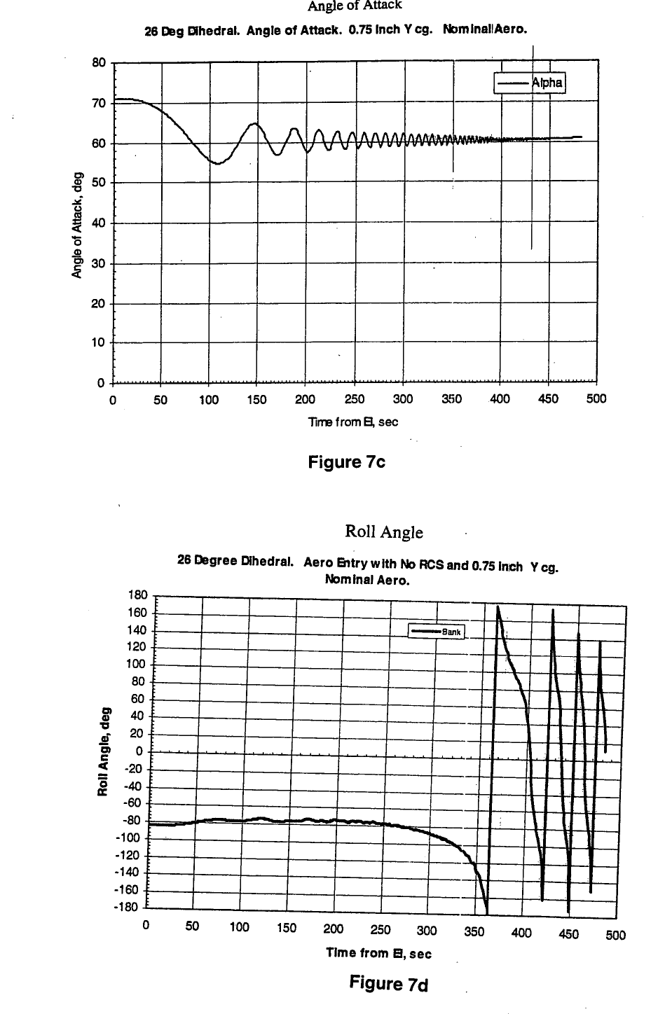

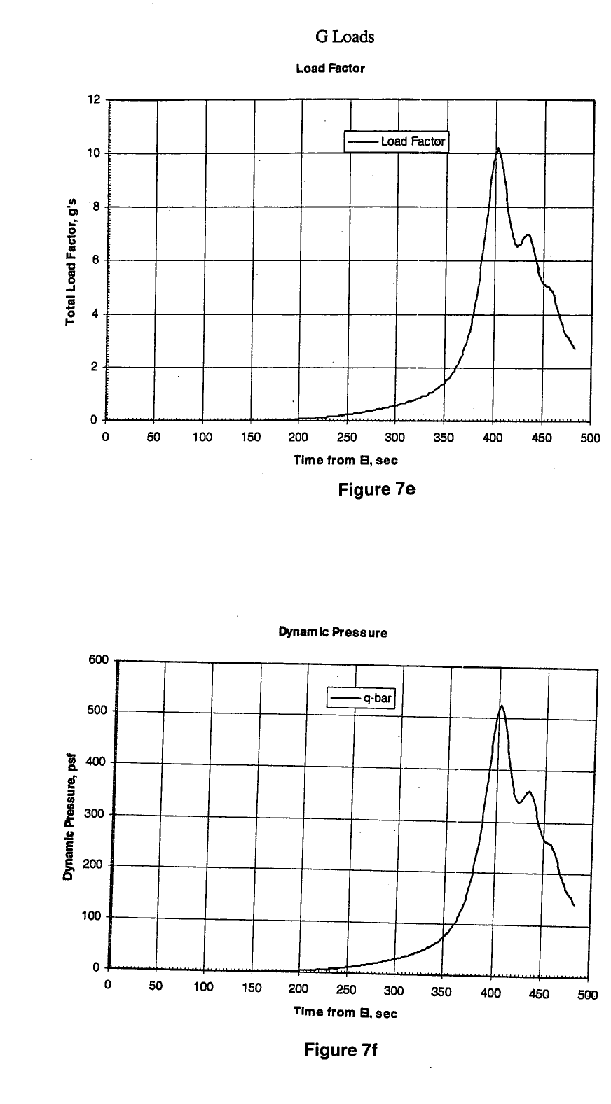

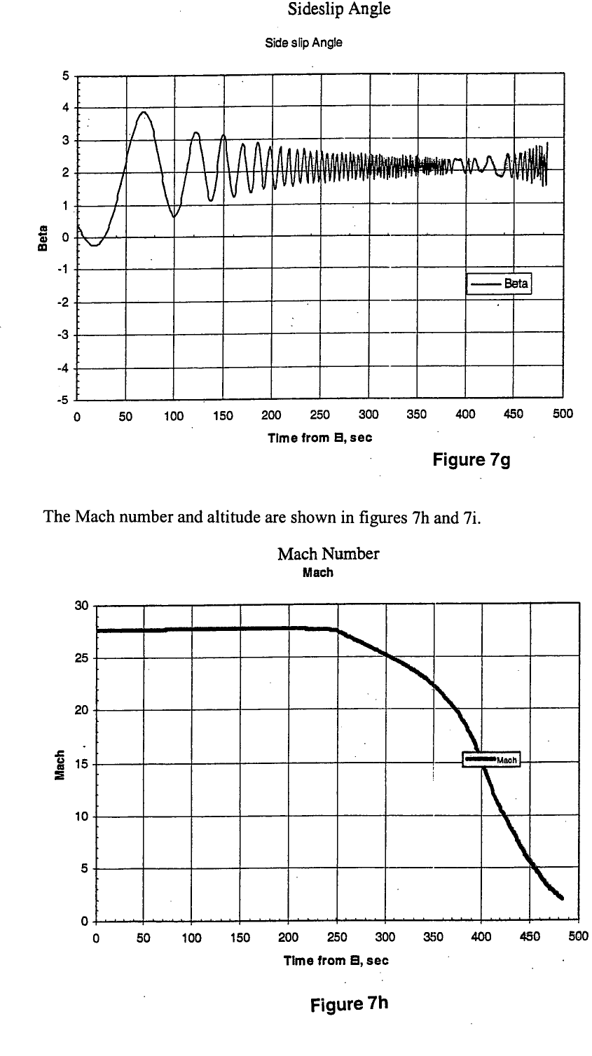

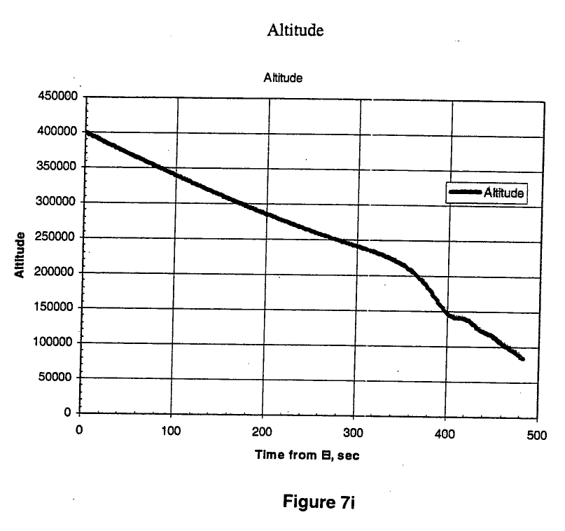

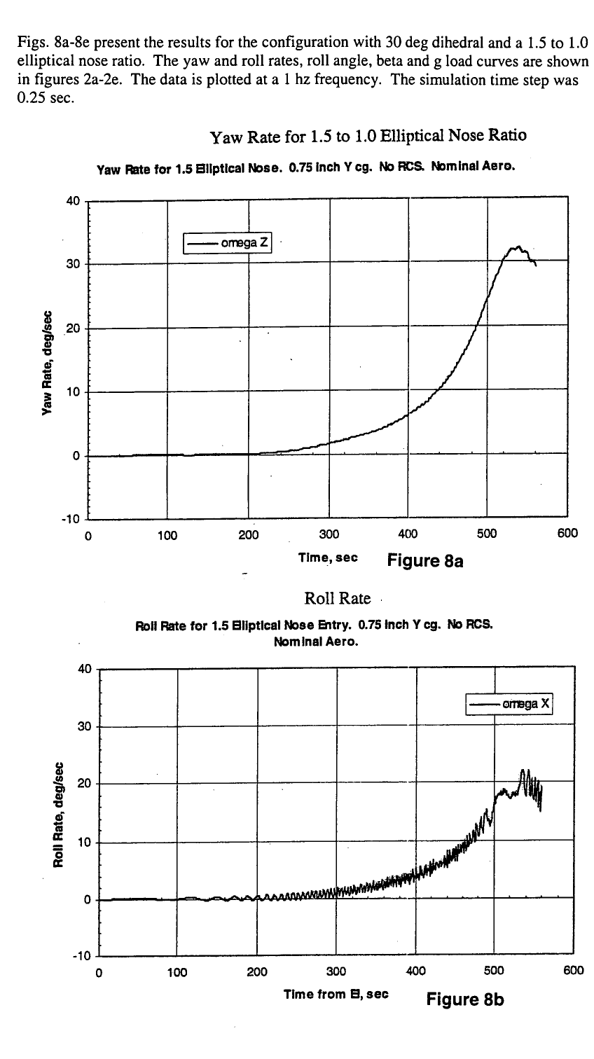

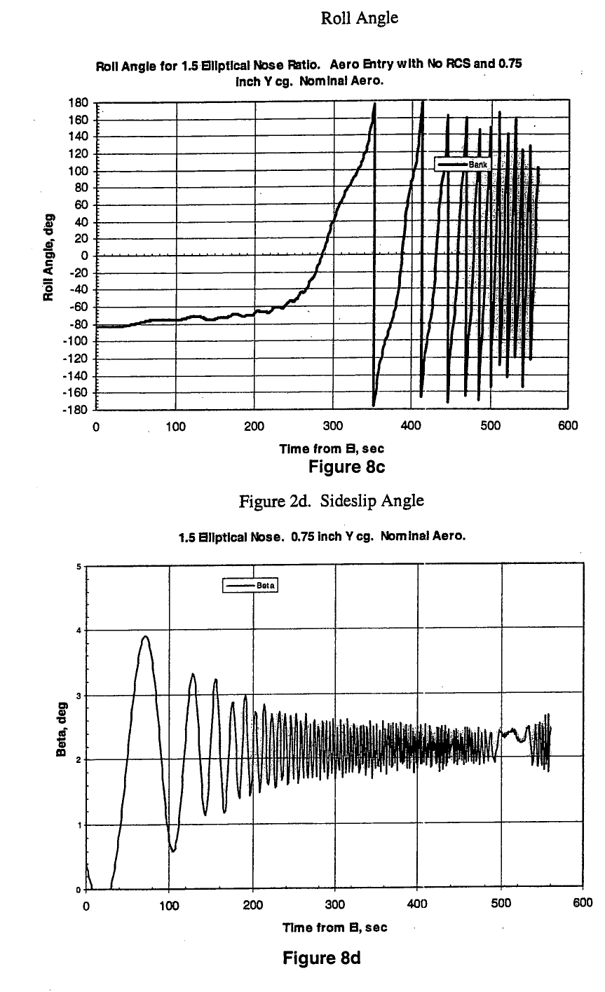

As shown in FIG. 6, surface approximation methods were implemented to assess aerodynamics during the tuning process which involved adjustments to a number of parameters as discussed above. Once a tuned design was thereby obtained, high fidelity flow analysis verified hypersonic flow field performance and stability characteristics as illustrated in FIG. 7. Finally, a test model was evaluated in the 14 inch Trisonic Wind Tunnel at NASA MSFC. The results of these analyses are summarized below. Though not shown, images were obtained to show the bow shock structure and to indicate surface shear stresses, so as to further validate design theory.

The noted simulation was used to evaluate the design criteria for two configuration designs for the uncontrolled ballistic entry which is the worst case for the Y cg offset. A Y cg of 0.75 inches was used for the validation since this is the maximum value being considered for entry. The previous OSP configurations lose control due to very large spin rates resulting from the Y cg. The simulations were run from entry interface at 400,000 ft. to the drogue chute deploy condition of Mach 2.

FIGS. 7a-7c show the simulation results for the configuration with a 2.0 to 1.0 elliptical nose ratio with 26 degree dihedral. The simulation was initiated at 400,000 ft. altitude with 0 rates and no control. Mach 10 aerodynamic data which is representative of the entire hypersonic Mach range was used for the validation simulation.

The yaw and roll rates in FIGS. 7a and 7b are less than 15 deg./sec. Indicating the design is very close to satisfying the design criteria for trimming the Y cg without control.

The angle of attack and bank angle are shown in FIGS. 7c and 7d. The Trim angle attack for the 26 deg dihedral configuration is about 60 degrees. The slow bank rotation results from the low yaw and roll rates.

FIGS. 7c and 7f show the g load and dynamic pressure time histories. The g load is a littler larger than would be experienced by a vehicle given an initial rate of 20-30 deg/sec because the first slow roll rotation spends a fairly long time in the lift down orientation as seen in FIG. 7d.

FIG. 7f shows the vehicle is experiencing the high dynamic pressure region during this lift down orientation. This illustrates the desirability of entering the atmosphere with an appreciable rotational rate.

FIG. 7g shows the sideslip angle indicating approximately 2 degrees of beta is required to trim the 0.75 inch Y cg. For the given aerodynamics, the sideslip angle for trim is linearly proportional to the Y cg.

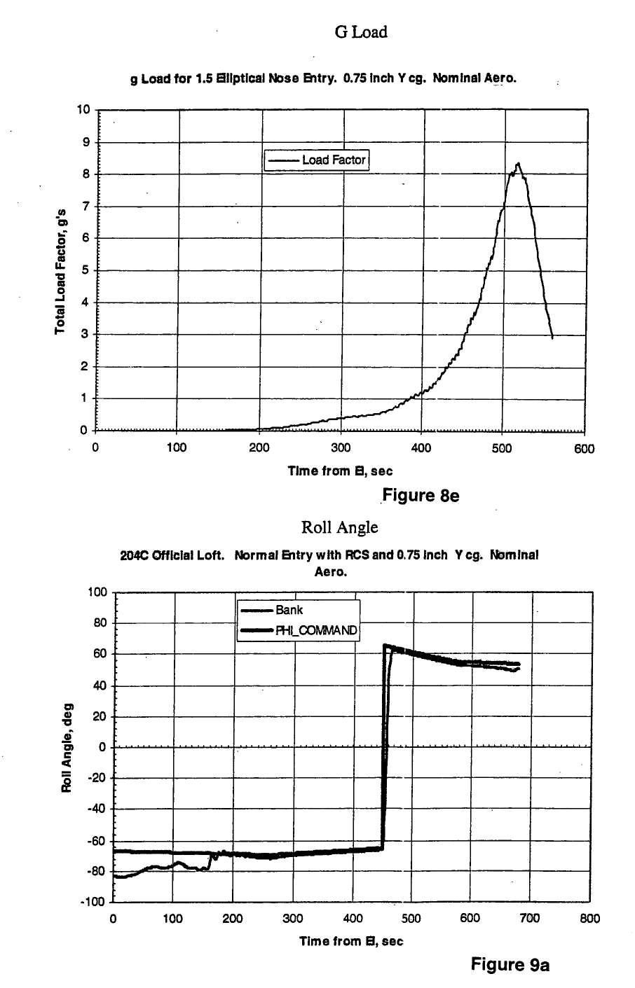

FIGS. 8a-8e present the results for the configuration with 30 deg. Dihedral and a 1.5 to 1.0 elliptical nose ratio. The yaw and roll rates, roll angle, beta, and g load curves are shown in FIGS. 2a-2e. The data is plotted at a 1 Hz. frequency. The simulation time step was 0.025 sec.

As was the case for the 26 degree dihedral case, the yaw and roll rates are relatively small with a maximum value 30 deg/sec. The trim sideslip angle of 2 degree is approximately the same as the 26 degree dihedral case. The load factor of 8 g's is a little lower than the 26 degree case because the roll angle spends less time in the left vector down orientation during the first revolution.

The simulation results validate the design criteria and show two independent vehicle parameters (dihedral and nose shape) that can be used to significantly reduce the sensitivity of the vehicle to Y cg offsets. In this regard, Y cg values in excess of 0.25 inches, for example, 0.75 inches, are accommodated, representing a substantial improvement in sensitivity. When the lower Mach abort conditions are factored into the design, it is possible that a combination of dihedral and nose change will provide the optimum configuration.

Minor modifications were made to the 26 degree dihedral configuration and data was generated for an official loft configuration. Simulations were run with this data for a normal entry scenario where the vehicle is controlled by the RCS. A flight control system (FCS) based on the Space Shuttle Orbiter/X-38 was developed for the entry control. The FCS uses control about all three body axes. The pitch axis is used only for damping after appreciable dynamic pressure is available. A pitch moment of 100 ft-lb with a large deadband was used in the model. The yaw and roll axis use bank error and stability axis angular rates for control with 1800 ft-lb yaw and 600 ft-lb roll moments. The large moments were incorporated to insure trim capability in the presence of large Y cg and aerodynamic uncertainties. An open loop guidance was incorporated with a bank angle profile that produces 2.5-3.0 g's during entry and has one bank reversal. It is assumed that the g limit for the normal entry will be around 2.5 g's and the RCS trim requirements is proportional to the g load. The simulation was flown with 0.75 inch Y cg with the nominal aerodynamics.

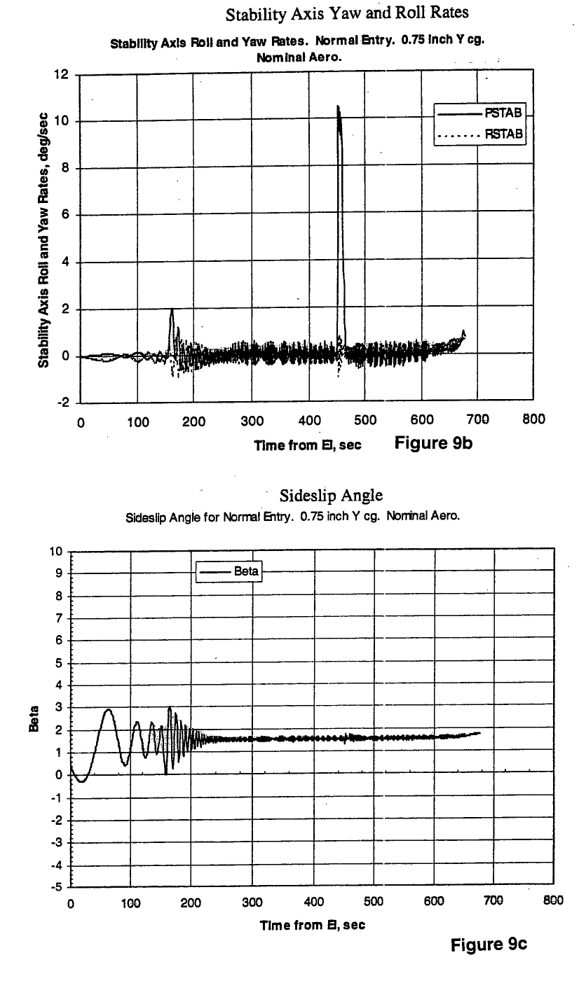

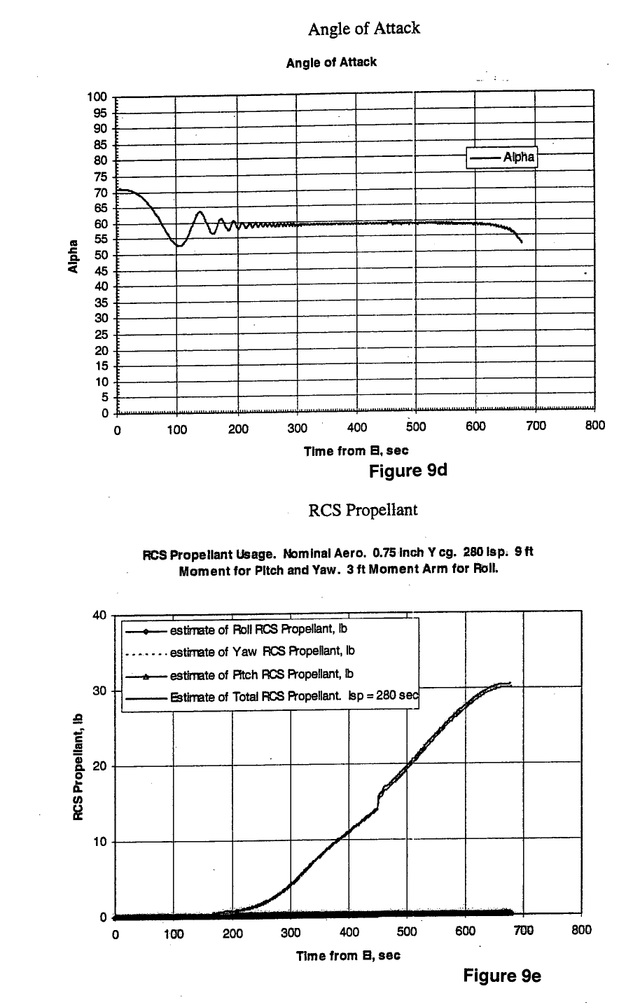

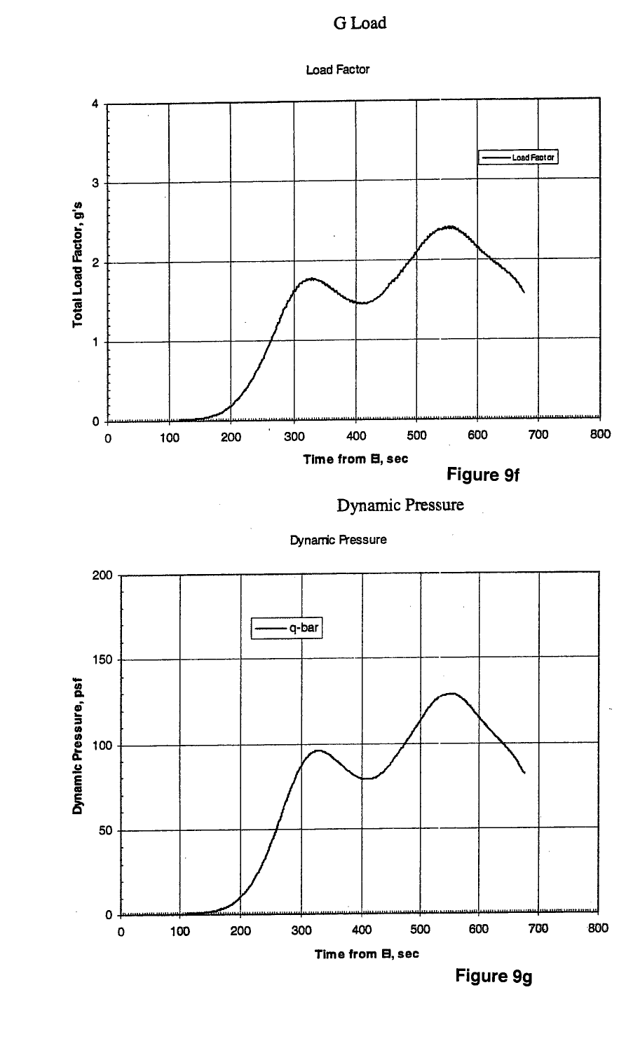

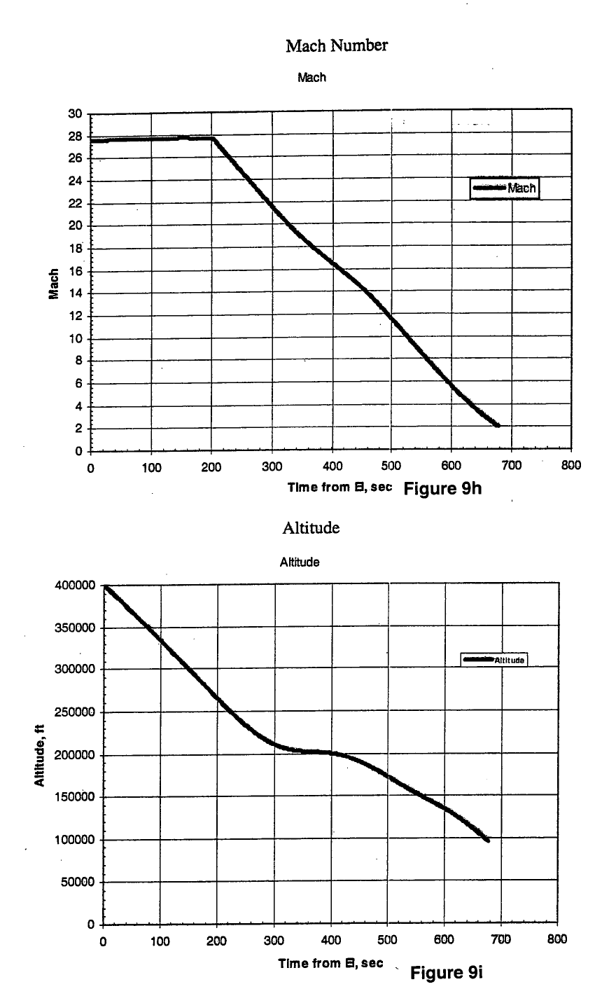

FIGS. 9a-9i show the simulation results for the normal entry with termination at the approximate drogue chute deploy conditions at Mach 2. FIG. 9a shows the vehicle closely follows the commanded roll angle after the FCS is activated at 5 psf dynamic pressure. The stability axis roll (phi dot) and yaw (beta dot) rates are shown in FIG. 9b. The RCS deadbands allow oscillations within about +/−1 deg/sec except during the bank reversal when phi dot goes to the commanded value of 10 deg/sec. FIG. 9c shows the beta value of 3 degrees required to trim the 0.75 inch Y cg when combined with the RCS. The value holds constant down to the chute deploy at Mach 2. The angle of attack in FIG. 9d holds constant at 59 degrees down to Mach 5 and then starts to decrease between Mach 5 and Mach 2. FIG. 9e shows a RCS propellant requirement of about 35 lb. Because of the large pitch and roll deadbands, almost all of the propellant use comes from the yaw axis, indicating the control system is almost a single axis controller. The strong CnBeta Dynamic allows a single axis (yaw) controller to be used. The g load, dynamic pressure, Mach number and altitude are shown in FIGS. 9f-9i. As mentioned earlier, the commanded bank was selected to generate 2.5-3 g's to insure the RCS is adequate. The commanded bank angle can be optimized to improve the phugoid type oscillations.

The normal entry was also run using the X-38 aerodynamic uncertainties combined with the Y cg. The X-38 uncertainties are based on historical data as well as X-38 wind tunnel and CFD results. Table 1 shows the X-38 uncertainties as a function of Mach number.

TABLE 1
X-38 Aero Uncertainties

| | | | | | | | | | | | | |
|---|---|---|---|---|---|---|---|---|---|---|---|---|
| Mach | 1.1 | 1.4 | 1.7 | 2.0 | 2.5 | 3.0 | 4.0 | 4.63 | 5.5 | 12 | 20 | 25 |
| Cm | .01 | .0068 | .0065 | .0061 | .0054 | .0048 | .0047 | .0047 | .0045 | .0045 | .0054 | .0060 |
| Mach | 1.05 | 1.1 | 1.4 | 1.7 | 3.0 | 4.0 | 4.63 | 5.5 | 15 | 20 | | |
| CnBeta | .056 | .0493 | .0493 | .0457 | .0457 | .0326 | .0273 | .02 | .0251 | .0336 | | |

Per rad based in lref

| | | | | |
|---|---|---|---|---|
| Mach | 1.1 | 4.0 | 15 | 20 |
| ClBeta | .045 | .03 | .03 | .0325 |

Per rad based on lref

| | | | | | |
|---|---|---|---|---|---|
| Mach | 1.1 | 4.63 | 5.5 | 12 | 20 |
| CA | .03 | .03 | .0252 | .0252 | .03 |

Set to X-38 CD uncertainty

| | | | |
|---|---|---|---|
| Mach | 1.1 | 12 | 20 |
| CN | .03 | .03 | .0333 |

Set to X-38 CL uncertainty

Note that the CnBeta and ClBeta values are referenced to the X-38 reference length and not the span. Therefore for a one to one correlation with the OSP these uncertainties should be multiplied by the reference length instead of the span. The reference length was used in the current analysis. The X-38 provided uncertainties for CL and CD instead f CA and CN. Since the CL and CD uncertainties are approximately the same, using these values for CA and CN is valid.

The X-38 damping derivatives were also used for the OSP analysis. Table 2 shows the primary X-38 damping derivatives which are constant for Mach numbers above 2. the X-38 non-dimensionalized the damping derivatives by 1/Vinf while the GEMASS simulation uses ½ Vinf (the more common approach in the US). Therefore the X-38 damping derivatives were multiplied by 2 for the OSP application. Because the X-38 uses only the reference length and not the span for the lateral directional coefficients, the adjusted X-38 damping derivatives should be applied to the OSP reference length. This approach was used for the current study.

TABLE 2
X-38 Damping Derivatives
(adjusted from 1/Vinf to ½ Vinf for the OSP)
(use lref in equations instead of b)

| Damping Derivative | Value, per rad/sec |
|---|---|
| Cmq | −0.32 |
| Cnr | −0.218 |
| Clp | −.0868 |

The aerodynamic uncertainties were combined in the worst combination for the Y cg trim when applied to the nominal aerodynamics (+Cm, +CA, −CN, −CnBeta, +ClBeta). Multipliers were then applied to the aero coefficients and to the Y cg to provide a conservative estimate of an equivalent combined 3 sigma case. For 6 significant variables (aero+Y cg), the multiplier is 0.61. For 4 significant variables the multiplier is 0.67 and for 2 significant variables the multiplier is 0.81. With the Y cg and 5 aerodynamic uncertainties listed above, a multiplier of 0.61 will yield the equivalent 3 sigma case (1 failure in 370 cases).

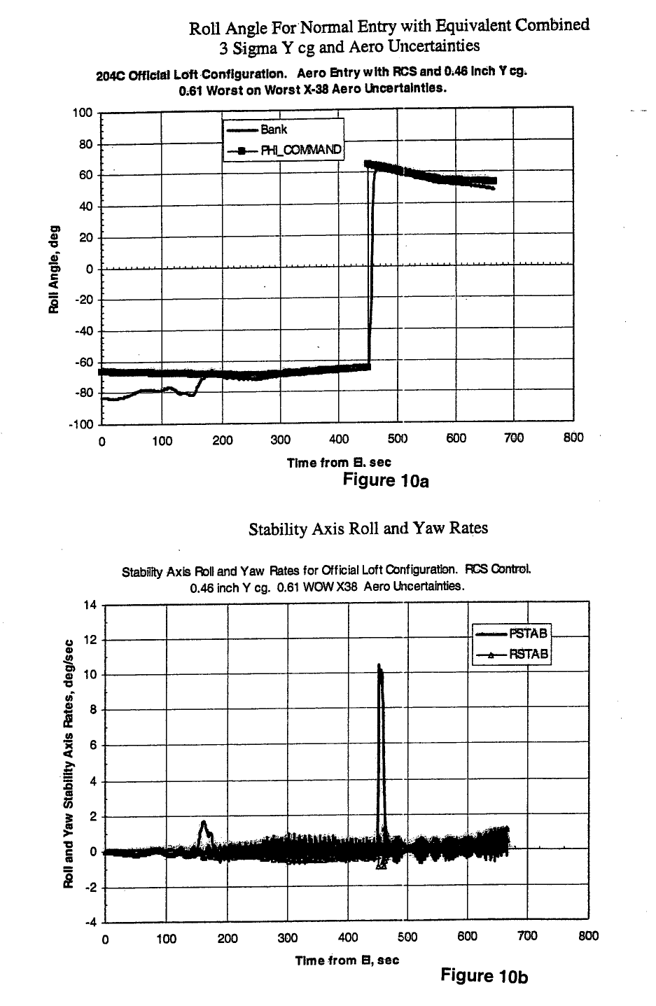

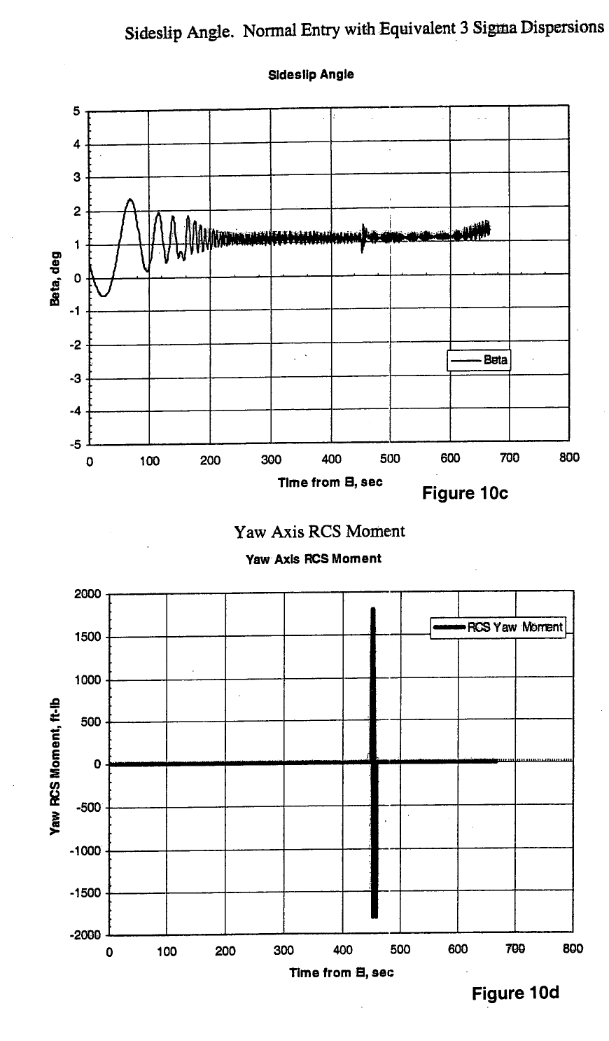

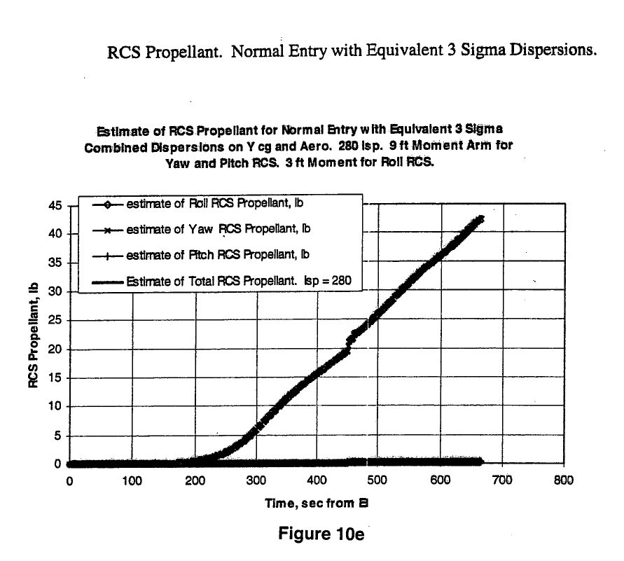

FIGS. 10a-10e show the simulation results with a multiplier of 0.61 applied to the Y cg and to the 5 aerodynamic uncertainties. FIG. 4a shows the vehicle follows the commanded roll angle about the same as for the nominal case in FIGS. 3a-3i. As a result, all of the trajectory parameters are almost the same as those in FIGS. 9a-9i and are not repeated here. FIG. 10b shows slightly larger roll and yaw rate oscillations than for the nominal (2 deg/sec vs. 1 deg/sec) and the sideslip angle in FIG. 10c is similar to the nominal case. FIG. 10e shows a 50% increase in propellant compared with the nominal case. Although the Yaw RCS shows a lot of activity, it is not nearly saturated as can be determined from the propellant use. As with the nominal case, very little propellant is required for the roll and pitch RCS. The total propellant use is less than 50 lbs. It can be concluded that the OSP configuration used for this analysis exhibits very good characteristics for the normal entry.

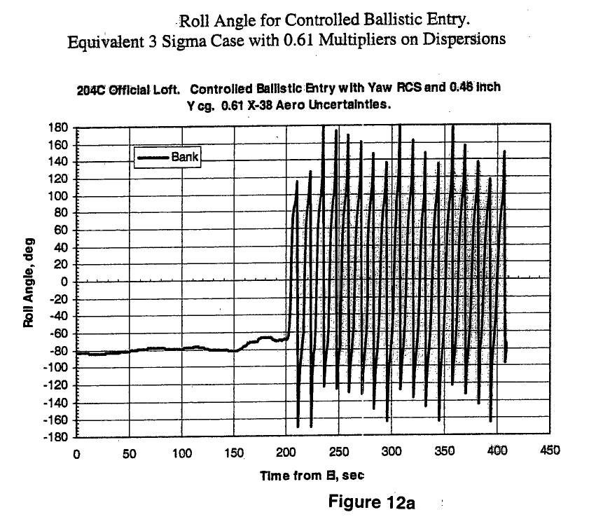

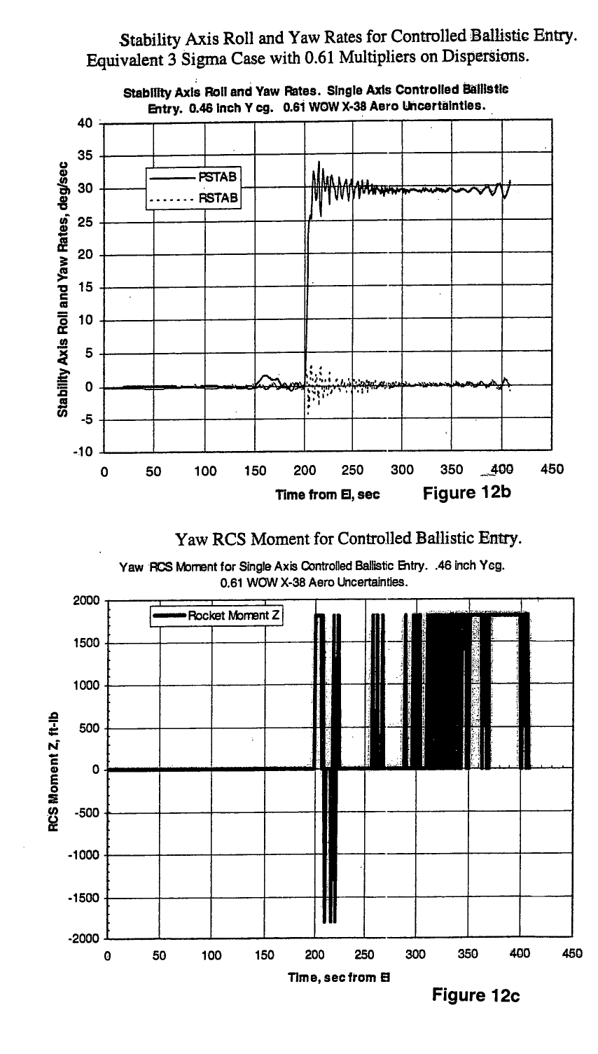

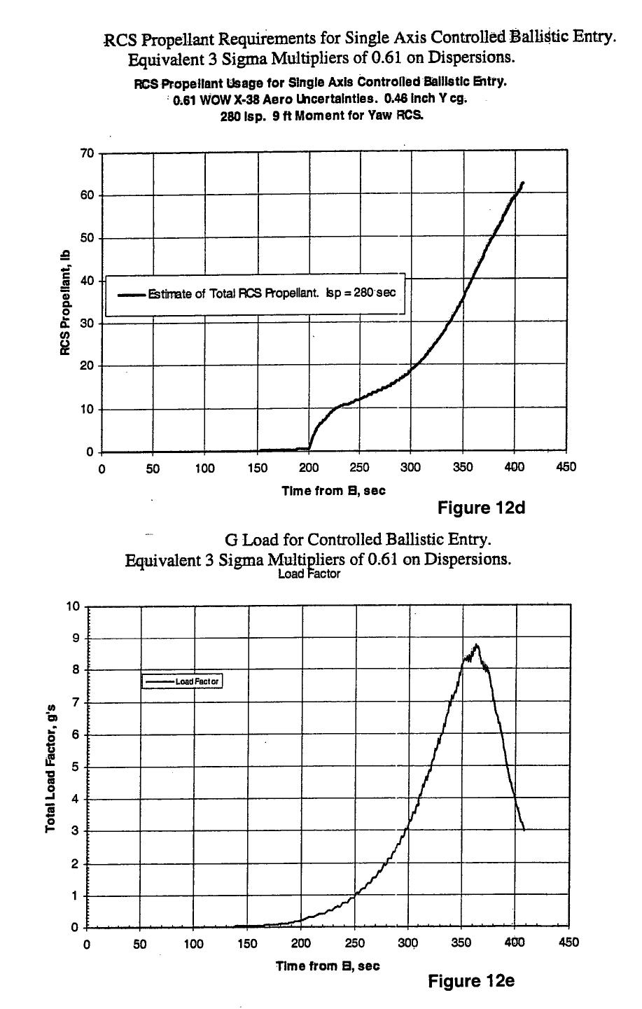

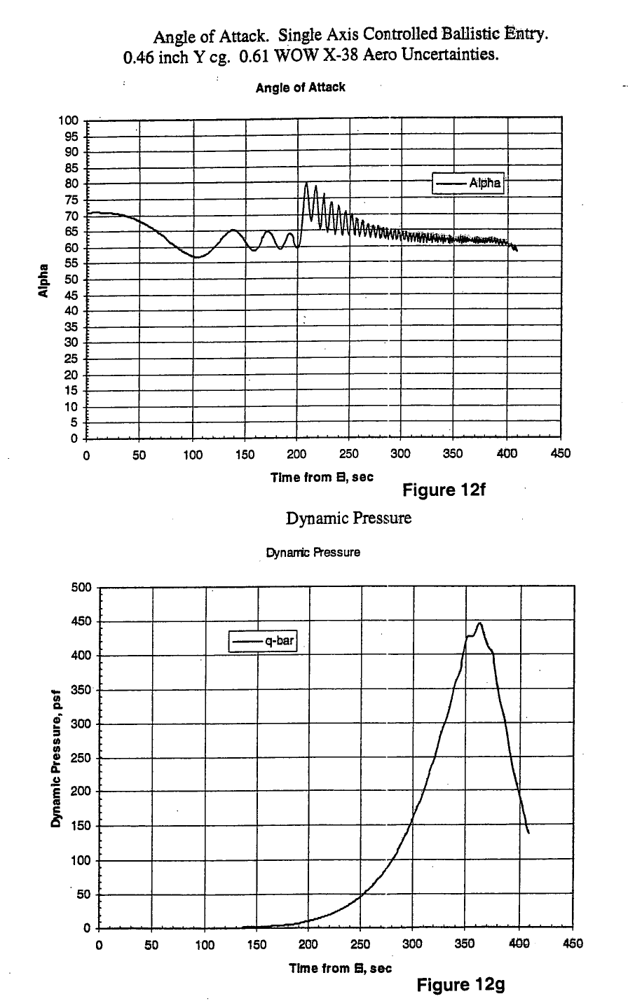

A series of controlled ballistic runs were made with a 30 deg/sec bank rate initialized at a dynamic pressure of 10 psf and then maintained throughout entry with a single axis (yaw) RCS controller. The same basic RCS controller used for the normal entry was used for the yaw axis but the roll and pitch RCS were disabled. FIGS. 12a-12g show the simulation results for the equivalent combined 3 sigma case with multipliers of 0.61 on the Y cg and aero uncertainties. FIG. 12a shows the roll angle and FIG. 15b shows the stability axis roll and yaw rates. The bank rate of 30 deg/sec is maintained throughout the trajectory. FIG. 12b shows a gradual increase in the angular rate oscillations as the dynamic pressure starts to decrease at the end but this should not cause any problems. The yaw RCS moment is shown in FIG. 12c and RCS propellant shown in FIG. 12d. The yaw RCS is saturated in the maximum dynamic pressure region around 360 seconds but the roll rate remains at the commanded value of 30 deg/sec. FIG. 12e shows a maximum g load of around 9 g's corresponding to the maximum dynamic pressure of 450 psf in FIG. 12g. FIG. 12f shows an increase of 5-10 degrees in angle of attack due to inertia coupling from the roll and yaw rates after the bank rate is initialized. The angle of attack migrates back toward the trim value of 62 degrees (with Cm uncertainties) as the dynamic pressure increases.

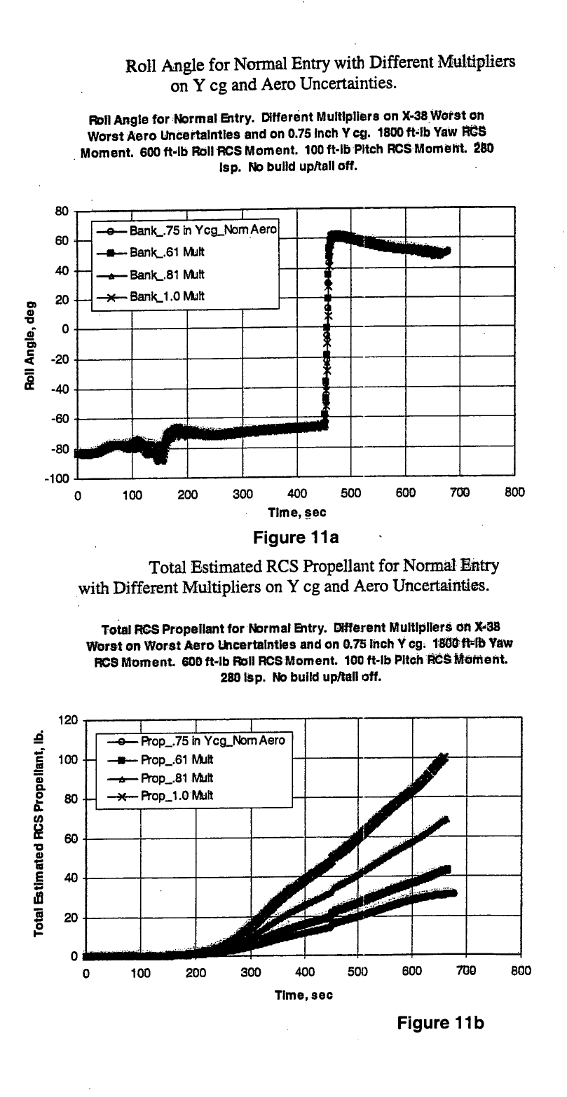

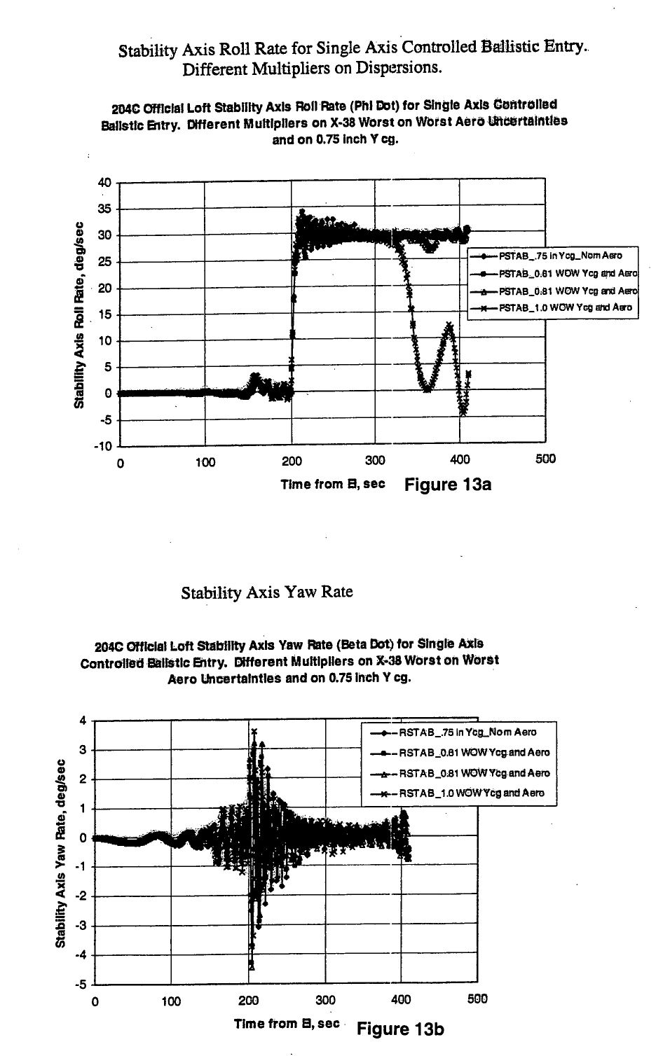

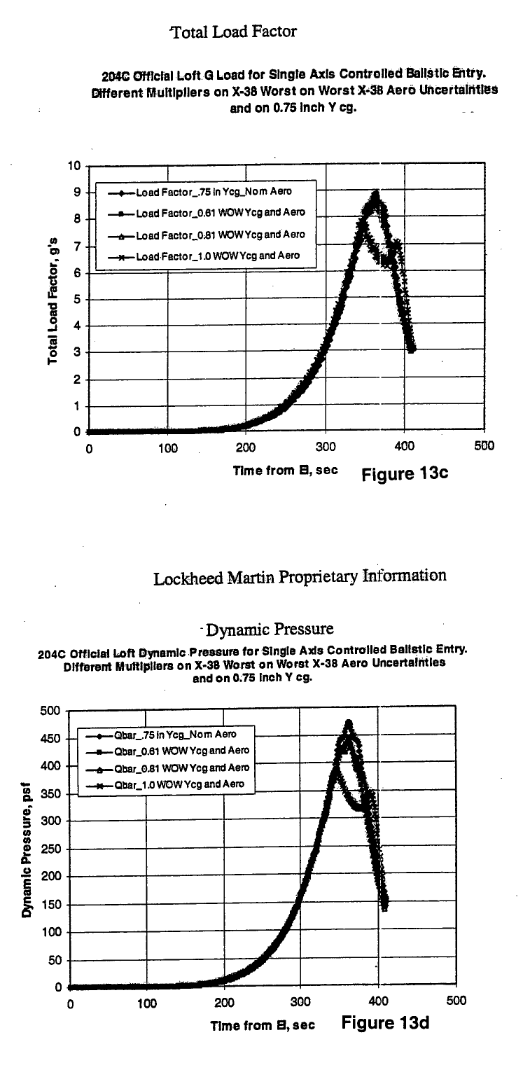

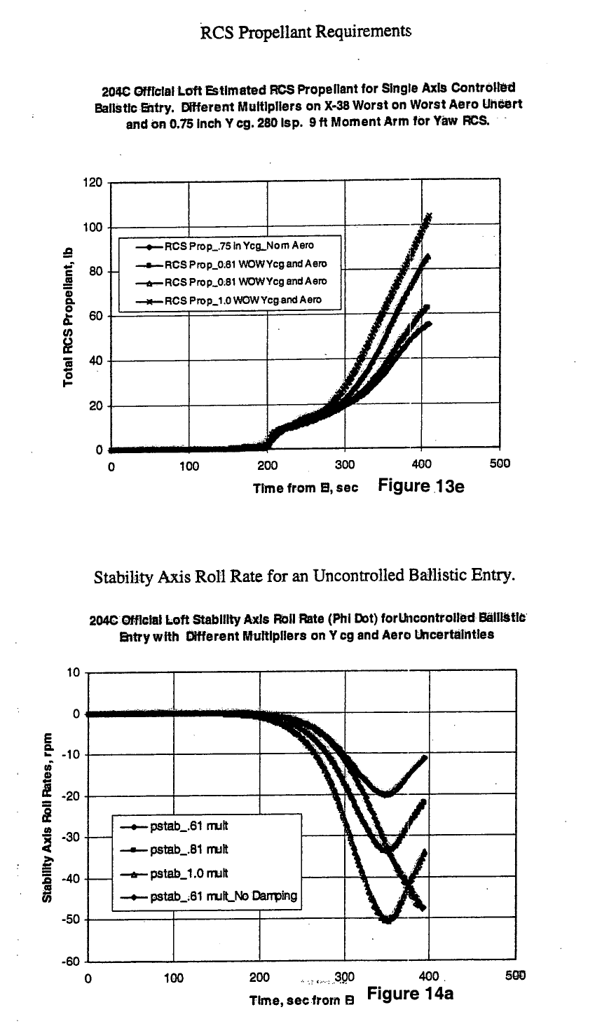

FIGS. 3a-13e show a compilation of the controlled ballistic entry results with multipliers on the Y cg and aero uncertainties varying from 0.61 to 1.0. With the equivalent 3 sigma multiplier of 0.61 on the Y cg and aero uncertainties, FIG. 13a shows the 30 deg/sec bank rate is maintained throughout the entry. When the multiplier is increased to 0.81, the bank rate decreases slightly from the commanded value in the peak dynamic pressure region of 450 psf but this does not significantly change the trajectory. When the multiplier is increased to 1.0 the 1800 ft-lb yaw jets are usable to maintain the bank rate. FIG. 13d indicates the dynamic pressure is significantly reduced after the bank rate is reduced. If the timing of the rate decrease had been different it is possible that the bank angle could have been at a lift down orientation and the dynamic pressure could have increased substantially. Therefore the 10 multiplier case is unacceptable with the 1800 ft-lb RCS. Since the 0.61 and 0.81 multiplier cases are acceptable, 1800 ft-lb RCS moment should be adequate. FIG. 13c shows a maximum load factor of 9 g's for the four cases and FIG. 13e shows a maximum propellant requirement of 60-100 lb. For the 3 sigma multipliers the results for the single axis controlled ballistic entry appear to be good.

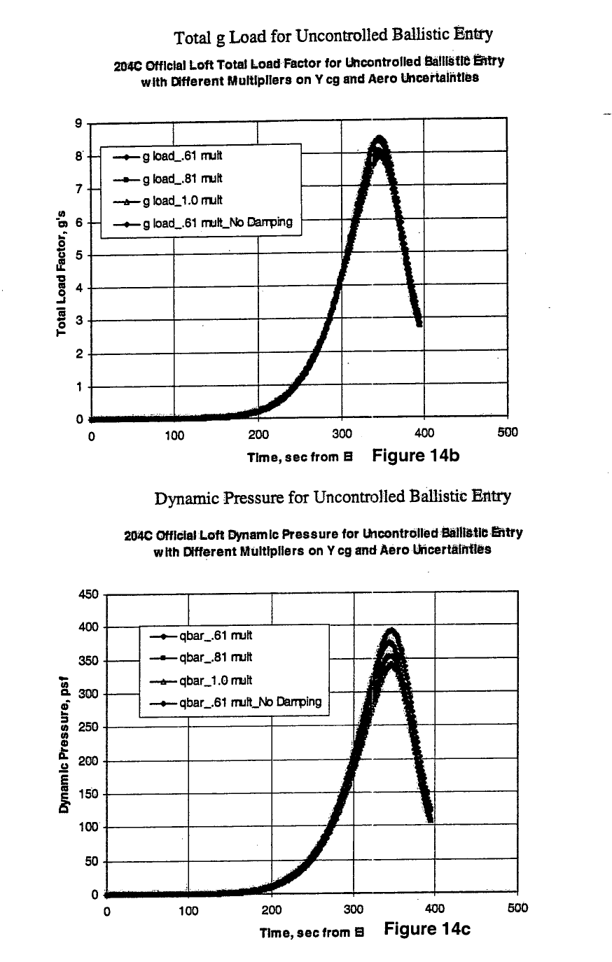

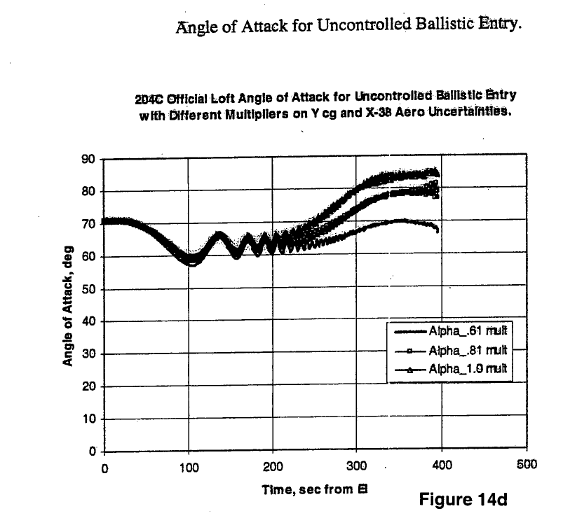

FIGS. 14a-14d show the simulation results for an uncontrolled ballistic entry initiated at 400,000 ft. altitude with no initial rates and different multipliers on the Y cg and aerodynamic uncertainties. If there is some known Y cg in the vehicle (probably 0.2 inch or greater), then this Y cg can be assumed to spin the vehicle up resulting in the desired ballistic entry. Without the Y cg assumption, the vehicle will need to be spun up to around 30 deg/sec (preferably early in the entry profile but with a dynamic pressure on the order of 5 psf or greater). This still leaves the possibility of a Y cg counteracting the initial spin rate and reversing the roll rate as the dynamic pressure builds up. If the rate reversal occurs during a lift down orientation, larger dynamic pressures may result.

FIG. 14a shows stability axis roll rates varying from −20 rpm (−120 deg/sec) to −50 rpm (−300 deg/sec) as the multiplier is increased from the equivalent 3 sigma value of 0.61 to 1.0. The roll rate with no damping is also shown for the 0.61 multiplier case in FIG. 14a. The more than 100% increase without damping compared to the damped case points out the importance of establishing reasonably good damping derivatives for the OSP in the angle of attack range occurring during the uncontrolled entry. The g loads and dynamic pressure are shown in FIGS. 14b and 14c. The maximum g load of 8.5 is slightly lower than the controlled ballistic entry cases. This is due to the high yaw and roll rates of attack for the different cases and shows increases from the static trim value of about 8 to 20 degrees depending on the case.

Two design solutions for desensitizing the OSP lifting body to Y cg offsets have thus been developed. Aerodynamic characteristics for an official loft of one of the configurations was able to successfully fly a normal entry, a single axis controlled ballistic entry and an uncontrolled ballistic entry in the presence of an equivalent combined 3 sigma case with variations in the Y cg offset and aerodynamic uncertainties.

While various embodiments of the present invention have been described in detail, further modifications and adaptations of the invention may occur to those skilled in the art. However, it is to be expressly understood that such modifications and adaptations are within the spirit and scope of the present invention.

What is claimed:

1. A re-entry vehicle for re-entering the Earth's atmosphere comprising:
a central body portion; and
at least one lifting surface extending from said body and configured so as to provide aerodynamic lift during at least a first portion of a descent path through the Earth's atmosphere from an outer extent of said atmosphere to the Earth's surface;
wherein, for specified initial conditions regarding re-entry, said re-entry vehicle is configured in a manner that enables passive re-entry such that a status of said re-entry vehicle with respect to each of a pitch, a roll and a yaw axis can be maintained within defined limits throughout at least a second portion of said descent path extending through said Earth's atmosphere substantially free from use of control thrusters for angular instability control.

2. A re-entry vehicle as set forth in claim 1, wherein said central body portion includes a passenger compartment

3. A re-entry vehicle as set forth in claim 1, wherein said re-entry vehicle is configured so as to substantially passively maintain a desired attitude through said first portion of said descent path.

4. A re-entry vehicle as set forth in claim 1, wherein said re-entry vehicle is configured so as to maintain any angular motion of said re-entry vehicle with respect to each of a yaw, a roll and a pitch axis within defined limits throughout said first portion of said descent path.

5. A re-entry vehicle as set forth in claim 1, wherein said re-entry vehicle is configured so as to maintain any angular motion of said re-entry vehicle with respect to each of a yaw, a roll and a pitch axis within NASA's human rating requirement.

6. A re-entry vehicle as set forth in claim 1, wherein said re-entry vehicle includes first and second wing portions extending from opposite sides of said central body portion.

7. A re-entry vehicle as set forth in claim 6, wherein said re-entry vehicle has a bottom surface adapted for generally facing a wind vector during re-entry and said wing portions have a dihedral configuration such that each of said wing portions is upwardly inclined from an inner end to a wingtip of each of said wing portions.

8. A re-entry vehicle as set forth in claim 7, wherein each of said wing portions has a downwardly convex shape relative to an axis extending between said inner end and said wingtip of each said wing portion.

9. A re-entry vehicle as set forth in claim 6, wherein said re-entry vehicle has a longitudinal axis extending from a nose and to a tail end thereof, wherein said nose end is adapted for generally facing a wind vector during re-entry and said wing portions have a rearwardly swept configuration from inner ends to wingtips thereof.

10. A re-entry vehicle as set forth in claim 9, wherein each of said wing portions has a downwardly convex shape relative to an axis extending from a leading edge to a trailing edge thereof.

11. A re-entry vehicle as set forth in claim 6, wherein each of said wing portions has a first axis extending from an inner end to a wingtip thereof and a second axis extending from a leading edge to a trailing edge thereof, and each of said wing portions further has a biconvex configuration defined by a downwardly convex shape relative to each of said first and second axes.

12. A re-entry vehicle as set forth in claim 6, wherein each of said wing portions has a curved trailing edge.

13. A re-entry vehicle as set forth in claim 6, wherein each of said wing portions has a rearwardly convex shape.

14. A re-entry vehicle as set forth in claim 6, wherein said first and second wing portions define a continuous lower surface.

15. A re-entry vehicle as set forth in claim 1, wherein said re-entry vehicle has a broadened nose at a front end thereof, wherein said broadened nose has a first dimension measured from side-to-side thereof and a second dimension, measured from to-to-bottom thereof, wherein said first dimension is greater than said second dimension.

16. A re-entry vehicle as set forth in claim 15, wherein said first dimension is at least about twice said second dimension.

17. A re-entry vehicle as set forth in claim 15, wherein said broadened nose is generally in the shape of an ellipsoid.

18. A re-entry vehicle for re-entering the Earth's atmosphere comprising:
internal structure defining a payload compartment; and
external structure defining a lifting body wherein, for a given attitude, said external structure provides a lift-to-drag ratio greater than about 0.3;
wherein, for specified initial conditions regarding re-entry, said re-entry vehicle is configured in a manner that enables passive re-entry such that a status of said re-entry vehicle with respect to each of a pitch, a roll and a yaw axis can be maintained within defined limits throughout at least a first portion of a descent path extending through an upper area of said Earth's atmosphere substantially free from use of control thrusters for angular instability control.

19. A re-entry vehicle as set forth in claim 18, wherein said payload compartment is adapted for accommodating a human passenger.

20. A re-entry vehicle as set forth in claim 18, wherein said external structure includes a central body portion and at least one lifting surface extending from said body portion.

21. A re-entry vehicle as set forth in claim 18, wherein, for said given attitude, said external structure provides a lift-to-drag ratio greater than about 0.6.

22. A re-entry vehicle as set forth in claim 18, wherein said external structure defines at least one aerodynamic control surface for aerodynamically controlling an attitude of said vehicle during at least a portion of a descent path through the Earth's atmosphere.

23. A re-entry vehicle as set forth in claim 18, wherein said external structure includes dihedral wings.

24. A re-entry vehicle as set forth in claim 23, wherein each of said wings has a rearwardly convex trailing edge.

25. A re-entry vehicle as set forth in claim 18, wherein said external structure includes a broadened nose at a front end thereof wherein said broadened nose has a first dimension measured from side-to-side thereof and a second dimension measured from top-to-bottom thereof, wherein said first dimension is greater than said second dimension.

26. A re-entry vehicle as set forth in claim 25, wherein said broadened nose has a generally ellipsoid configuration.

27. A re-entry vehicle for re-entering the Earth's atmosphere comprising:
internal structure defining a payload compartment; and
external structure defining a lifting body wherein, for a given angle of attack relative to a wind vector, said external structure provides a lift-to-drag ratio greater than about 0.6;
wherein, for specified initial conditions regarding re-entry, said re-entry vehicle maintains passive control with respect to at least one of a yaw, a roll and a pitch axis such that a status with respect to said one axis is maintained within defined limits throughout at least a first portion of said descent path extending through an upper area of said Earth's atmosphere substantially free from use of control thrusters for angular motion control with respect to said one axis.

28. A re-entry vehicle as set forth in claim 27, wherein said payload compartment is adapted for accommodating a human passenger.

29. A re-entry vehicle as set forth in claim 27, wherein said external structure includes a central body portion and at least one lifting surface extending from said body portion.

30. A re-entry vehicle as set forth in claim 27, wherein, for said given attitude, said external structure provides a lift-to-drag ratio greater than about 0.6.

31. A re-entry vehicle as set forth in claim 27, wherein said external structure defines at least one aerodynamic control surface for aerodynamically controlling an attitude of said vehicle during at least a portion of a descent path through the Earth's atmosphere.

32. A re-entry vehicle as set forth in claim 27, wherein said external structure includes dihedral wings.

33. A re-entry vehicle as set forth in claim 32, wherein each of said wings has a rearwardly convex trailing edge.

34. A re-entry vehicle as set forth in claim 27, wherein said external structure includes a broadened nose at a front end thereof wherein said broadened nose has a first dimension measured from side-to-side thereof and a second dimension measured from top-to-bottom thereof, wherein said first dimension is greater than said second dimension.

35. A re-entry vehicle for re-entering the Earth's atmosphere comprising:
a central body portion; and
at least one aerodynamic control surface for aerodynamically controlling an attitude of said vehicle during at least a portion of a descent path through the Earth's atmosphere from an outer extent of said atmosphere to the Earth's surface;
wherein, for specified initial conditions regarding re-entry, said re-entry vehicle is configured for passive re-entry such that a status of said re-entry vehicle with respect to each of a yaw, a roll and a pitch axis is maintained within defined limits throughout at least a first portion of said descent path extending through an upper area of said Earth's atmosphere substantially free from use of control thrusters for angular motion control.

36. A re-entry vehicle as set forth in claim 35, wherein said payload compartment is adapted for accommodating a human passenger.

37. A re-entry vehicle as set forth in claim 35, wherein said external structure includes a central body portion and at least one lifting surface extending from said body portion.

38. A re-entry vehicle as set forth in claim 35, wherein, for said given attitude, said external structure provides a lift-to-drag ratio greater than about 0.6.

39. A re-entry vehicle as set forth in claim 35, wherein said external structure defines at least one aerodynamic control surface for aerodynamically controlling an attitude of said vehicle during at least a portion of a descent path through the Earth's atmosphere.

40. A re-entry vehicle as set forth in claim 35, wherein said external structure includes dihedral wings.

41. A re-entry vehicle as set forth in claim 40, wherein each of said wings has a rearwardly convex trailing edge.

42. A re-entry vehicle as set forth in claim 35, wherein said external structure includes a broadened nose at a front end thereof wherein said broadened nose has a first dimension measured from side-to-side thereof and a second dimension measured from top-to-bottom thereof, wherein said first dimension is greater than said second dimension.

43. A method for use in re-entry and descent, comprising the steps of:
controlling a re-entry vehicle so as to provide desired conditions for penetrating an outer extent of the Earth's atmosphere;
passively re-entering the Earth's atmosphere such that any angular motion of said re-entry vehicle with respect to each of a yaw, a roll and a pitch axis remains within defined limits throughout a first portion of a descent path extending through an upper area of said Earth's atmosphere substantially free from use of control thrusters for angular motion control; and
using aerodynamic surfaces of said re-entry vehicle to control a second portion of said descent path extending through a lower area of said Earth's atmosphere.

44. A method as set forth in claim 43, wherein said step of controlling comprises causing said re-entry vehicle to contact an outer extent of the Earth's atmosphere with a desired velocity, incidence angle relative to the atmosphere and attitude.

45. A method as set forth in claim 43, wherein said step of passively re-entering comprises maintaining an angular motion of said re-entry vehicle with respect to said yaw, roll and pitch axes within defined limits.

46. A method as set forth in claim 43, wherein said step of passively re-entering comprises maintaining any angular motion of said re-entry vehicle with respect to said pitch, roll and yaw axes within NASA's Human Rating Requirement.

47. A method as set forth in claim 43, wherein said step of using aerodynamic surfaces comprises using wing surfaces to generate lift.

48. A method as set forth in claim 43, wherein said step of using aerodynamic surfaces comprises using deployable aerodynamic surfaces to control an attitude of said re-entry vehicle.

49. A method as set forth in claim 43, further comprising the step of using thrusters to change an attitude of said vehicle from a first orientation to a second orientation.

50. A method for use in designing a re-entry vehicle comprising the steps of:
providing a proposed re-entry vehicle configuration; and
reducing a control requirement for re-entry stability control by aerodynamically tuning said proposed design so as to more closely satisfy the equation: c_{nβ}/c_{1β}=−C_{A}/C_{N} where:
c_{nβ}=yaw moment;
c_{1β}=roll moment;
C_{A}=axial force coefficient; and
C_{N}=normal force coefficient.

51. A method as set forth in claim 50, wherein said proposed re-entry vehicle configuration is a lifting body configuration having L/D ration greater than 0.3 and said step of reducing comprises turning said design so as to enable passive re-entry control.
